(19) United States
(12) Patent Application Publication
(10) Pub. No.: US 2012/0004379 A1
(43) Pub. Date: Jan. 5, 2012

(54) Initiator system for synthesizing high-vinyl diene rubbers, a method for producing high-vinyl diene rubbers, and use thereof to produce high-vinyl diene rubbers

(75) Inventor: Norbert Steinhauser, Monheim (DE)

(73) Assignee: LANXESS DEUTSCHLAND GMBH, Leverkusen (DE)

(21) Appl. No.: 13/201,679

(22) PCT Filed: Feb. 9, 2010
(86) PCT No.: PCT/EP2010/051532

§ 371 Date: Sep. 20, 2011

(30) Foreign Application Priority Data
Feb. 18, 2009 (DE) 10 2009 009 531.4

(51) Int. Cl. C08F 36/04; C08F 36/06; C08F 36/20; C08F 36/08; C09K 3/00; C08F 2/00

(52) U.S. Cl. 526/174; 252/182.14

(57) ABSTRACT

The present invention relates to an initiator system for synthesizing high-vinyl diene rubbers, to a method for producing diene homopolymers and diene copolymers having a high vinyl content at high polymerization temperatures, and to the use thereof to produce diene homopolymers and diene copolymers having a high vinyl content at high polymerization temperatures.

The present invention relates to an initiator system for the synthesis of high-vinyl-content diene rubbers, and to a production process and its use for the production of diene homopolymers and diene copolymers having high vinyl content at high polymerization temperatures. The resultant high-vinyl-content diene rubbers are particularly suitable for the production of tyres.

An important property desired in tyres is good adhesion to dry and wet surfaces. It is very difficult here to improve the skid resistance of a tyre without simultaneously impairing rolling resistance and abrasion resistance. Low rolling resistance is significant for low fuel consumption, and high abrasion resistance is the decisive factor for long tyre lifetime.

The wet skid resistance and rolling resistance of a tyre depend largely on the dynamic mechanical properties of the rubbers from which the tyre is constructed. In order to lower rolling resistance, rubbers with high rebound resilience at relatively high temperatures (from 60° C. to 100° C.) are used for the tyre tread. On the other hand, rubbers with a high damping factor at low temperatures (0° C.) or, respectively, having low rebound resilience in the range from 0° C. to 23° C. are advantageous for improving wet skid resistance. In order to comply with the said complex requirements profile, mixtures composed of various rubbers are used in the tread. The usual method uses mixtures composed of one or more rubbers with relatively high glass transition temperature, e.g. styrene-butadiene rubber, and of one or more rubbers with relatively low glass transition temperature, e.g. polybutadiene with high 1,4-cis content or, respectively, a styrene butadiene rubber having low styrene content and very low vinyl content or a polybutadiene produced in solution and having moderate 1,4-cis content and low vinyl content.

Polybutadienes having high vinyl content (1,2-bonded diene) are known from the literature and are suitable for the production of tyre mixtures with reduced rolling resistance and with good wet skid resistance, as described by way of example in U.S. Pat. No. 4,224,197. Polybutadienes having high vinyl content are preferably produced via anionic solution polymerization, requiring the use of polar substances, such as ethers or amines, as microstructure regulators during the polymerization process. In order to arrive at the range of >80% vinyl content that is of interest for improved wet skid resistance, the polymerization process must be carried out with use of the known microstructure regulators at relatively low temperatures below 80° C. By way of example, U.S. Pat. No. 4,224,197 refers to U.S. Pat. No. 3,301,840 for the synthesis of the polybutadienes described in the patent specification having vinyl content of >80%. The temperatures described in that document for the synthesis of the polybutadienes having vinyl contents >80% are 50° C. or lower, with a requirement for use of large amounts of microstructure regulators. However, low polymerization temperatures are economically disadvantageous, since the reaction mixture must be cooled and/or the solids content of the reaction mixture has to be lowered, to prevent any excessive rise of temperature during the polymerization process. In contrast, high polymerization temperatures are advantageous, since complicated cooling can be omitted to some extent or entirely, and the polymerization process can be carried out with relatively high solids content, resulting in higher productivity. Furthermore, a high polymerization temperature during anionic solution polymerization makes it easier to remove the solvent from the rubber once the polymerization process is complete. The additional use of sodium alkoxides or sodium phenoxides in anionic diene polymerization alongside the known microstructure regulators can lead to an increase in vinyl content. By way of example, U.S. Pat. No. 5,654,384 describes the anionic polymerization of butadiene using tetramethylethylenediamine as microstructure regulator and sodium tert-amyl alcoholate as sodium alkoxide component, at a polymerization temperature of 75° C. It is thus possible to produce polybutadienes with vinyl content of from 82-83% and with glass transition temperature of from −27° C. to −28° C. However, rubbers of particular interest for improving wet skid resistance are those having markedly higher glass transition temperatures.

It was an object to provide a novel initiator system which is especially suitable for anionic diene polymerization and which does not have the disadvantages of the prior art, and which also permits the use of high polymerization temperatures to produce polybutadienes having high vinyl content.

Surprisingly, it has now been found that an initiator system encompassing (A) at least one organolithium compound, (B) at least one di(aminoalkyl) ether and (C) at least one sodium alkoxide and/or sodium phenoxide does not have the disadvantages of the prior art and especially permits production of diene homopolymers and diene copolymers having high vinyl content at high polymerization temperatures. Furthermore, the diene homopolymers and diene copolymers produced with the initiator system of the invention have glass transition temperatures above −25° C., indeed mostly above −20° C., with resulting advantages in wet skid resistance.

The present invention therefore provides an initiator system for anionic polymerization comprising (A) at least one organolithium compound, (B) at least one di(aminoalkyl) ether and (C) at least one sodium alkoxide and/or sodium phenoxide.

The organolithium compound (A) is a mono-, di and/or polyfunctional compound. Preferred monofunctional compounds are compounds of the formula (I)

R-Li (I).

where R is an optionally substituted alkyl moiety having from 1 to 32 carbon atoms, an optionally substituted cycloalky) moiety having from 3 to 32 carbon atoms or an optionally substituted aryl moiety having from 5 to 36 carbon atoms, which optionally can contain one or more heteroatoms. It is preferable that the heteroatoms are nitrogen, oxygen and/or silicon. R can also be a secondary aliphatic, cycloaliphatic or aromatic amine moiety.

Examples of these organolithium compounds are methyllithium, ethyllithium, isopropyllithium, n-butyllithium, sec-butyllithium, pentyllithium, n-hexyllithium, cyclohexyllithium, octyllithium, decyllithium, 2-(6-lithio-n-hexoxy)tetrahydropyran, 3-(tert-butyldimethylsiloxy)-1-propyllithium, phenyllithium, 4-butylphenyllithium, 1-naphthyllithium, p-tolyllithium and/or lithium amides of secondary amines, e.g. lithium pyrrolidide, piperidide, lithium diphenylamide. The organolithium compounds (A) are commercially available products or can be produced via reaction of the corresponding halides with elemental lithium (see, for example, A. Streitwieser, C. H. Heathcock, Organische Chemie [Organic Chemistry], Verlag Chemie, Weinheim 1980, pages 192-194) or via reaction of secondary amines with organolithium compounds (see, for example, H. Beyer, Lehrbuch der Organischen Chemie [Textbook of Organic Chemistry], S. Hirzel Verlag, Stuttgart 1988, pages 185-186). However, the lithium amides can also be produced in situ via reaction of an organolithium compound with secondary (sec) amines.

Examples of suitable di- and polyfunctional organolithium compounds are 1,4-dilithiobutane, dilithium 1,6-hexamethylenediamide, dilithium piperazide. It is preferable to use n-butyllithium and/or sec-butyllithium.

Preferred di(aminoalkyl) ethers (B) are compounds of the general formula (II)

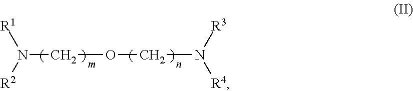

where

R¹, R², R³ and R⁴ are identical or different and are alkyl moieties having from 1 to 12 carbon atoms, preferably from 1 to 4 carbon atoms, cycloalkyl moieties having from 3 to 8 carbon atoms, preferably from 5 to 6 carbon atoms, aryl moieties having from 6 to 10 carbon atoms, preferably 6 carbon atoms, or aralkyl moieties having from 7 to 15 carbon atoms, preferably from 7 to 10 carbon atoms,

m and n are identical or different and are whole numbers from 1 to 8, preferably from 1 to 4.

It is preferable that the compound of the formula (II) is bis[2-(N,N-dimethylamino)ethyl] ether of the formula (IIa) below

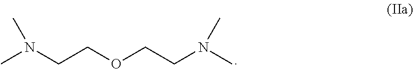

The di(aminoalkyl) ethers (B) can be produced by methods known from the literature, e.g. as described in EP-A 297 296.

The sodium alkoxide and/or sodium phenoxide (C) has the general formula (III)

Na—OR′ (III),

where R′ is a linear, branched, saturated or unsaturated optionally substituted C₁-C₃₀-alkyl, C₃-C₁₈-cycloalkyl or C₆-C₁₈-aryl moiety which optionally contains one or more heteroatoms. The heteroatoms are preferably oxygen and/or nitrogen.

Examples of compounds of the formula (III) are sodium methanolate, sodium ethanolate, sodium n-propanolate, sodium isopropanolate, sodium n-butanolate, sodium sec-butanolate, sodium tert-butanolate, sodium n-pentanolate, sodium iso-pentanolate, sodium hexanolate, sodium cyclohexanolate, sodium 2,4-dimethyl-3-pentanolate, sodium octanolate, sodium 2-ethylhexanolate, sodium decanolate, sodium 3,7-dimethyl-3-octanolate, sodium mentholate, sodium tetrahydrofurfuranolate, sodium phenolate, sodium p-nonylphenolate and/or sodium p-decylphenolate. It is also possible to use sodium alkoxides and sodium phenoxides of polyhydric alcohols. Examples here are disodium 1,6-hexanediolate and/or disodium 2,2′-methylenebis[6-(1,1-dimethylethyl)-4-methyl]phenoxide.

The compounds of the formula (III) are commercially available products or can be produced in a known manner via reaction of the corresponding alcohols and phenols with sodium.

In one embodiment of the invention, the initiator system of the invention comprises respectively one representative of components (A), (B) and (C). However, in another embodiment of the invention there are also a plurality of representatives of components (A), (B) and (C) present.

It is particularly preferable that the initiator system of the invention comprises n-butyllithium and/or sec-butyllithium as component (A), bis[2-(N,N-dimethylamino)ethyl] ether of the formula (IIa) as component (B), and sodium 3,7-dimethyl-3-octanolate and/or sodium mentholate as component (C).

The initiator system of the invention can moreover also comprise, alongside components (A), (B) and (C), the randomizers known from the literature for increasing the random incorporation of the vinylaromatic comonomers during the diene copolymerization process, examples being potassium alkoxides, potassium carboxylates, potassium amides, sodium sulphonates.

In another embodiment of the invention, the initiator system also comprises additional microstructure regulators, e.g. diethyl ether, di-n-propyl ether, diisopropyl ether, di-n-butyl ether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methylpropane, triethylene glycol dimethyl ether, tetrahydrofuran, ethyl tetrahydrofuryl ether, ditetrahydrofurylpropane, dioxane, trimethylamine, triethylamine, N,N,N′,N′-tetramethylethylenediamine, N-methylmorpholine, N-ethylmorpholine, 1,2-dipiperidinoethane, 1,2-dipyrrolidinoethane and/or 1,2-dimorpholinoethane.

The molar ratio of compound (B) to compound (A) is from 0.01:1 to 100:1, preferably from 0.05:1 to 10:1, very particularly preferably from 0.1:1 to 3:1.

The molar ratio of compound (C) to compound (B) is from 0.005:1 to 100:1, preferably from 0.025:1 to 20:1, very particularly preferably from 0,15:1 to 2:1.

The molar ratio of compound (C) to compound (A) is from 0.02:1 to 50:1, preferably from 0.1:1 to 10:1, very particularly preferably from 0.2:1 to 2:1.

The invention also provides the production of the initiator system of the invention, by mixing components (A) to (C) in any desired sequence. The mixing of the components here preferably takes place at room temperature.

The present invention also provides a process for the production of diene homopolymers and diene copolymers having vinyl content of >60%, preferably >80%, based on the diene component, by reacting the dienes and/or vinylaromatic monomers with the initiator system of the invention.

It is preferable that the process of the invention is carried out at polymerization temperatures of >60° C., preferably >75° C. The polymerization temperature stated also encompasses temperature gradients of from 20 to 160° C. in the reactor. However, it is also possible to initiate the process at below 0° C., for example at −20° C.

There are a number of ways of carrying out the process of the invention. In one embodiment of the invention, the monomers and/or vinylaromatic comonomers are first used as initial charge, and then the initiator system is added.

In one preferred embodiment of the invention, the monomers and/or vinylaromatic comonomers are first used as initial charge and then the individual components of the initiator system are added in any desired sequence.

In one preferred embodiment of the invention, the individual components (A) to (C) of the initiator system are first used as initial charge and then the monomers and/or vinylaromatic comonomers are metered into the mixture.

In one preferred embodiment of the invention, the individual components of the initiator system, e.g. (B) and/or (C), are first used as initial charge and then the monomers and/or vinylaromatic comonomers are introduced and then component (A) is introduced.

In another preferred embodiment, components (A) to (C), the monomers and/or vinylaromatic comonomers, and also the solvent are metered continuously into the reactor.

However, addition of components (B) and/or (C) can take place after initiation of the polymerization process.

Preferred dienes are 1,3-butadiene, isoprene, 1,3-pentadiene, 2,3-dimethylbutadiene, 1-phenyl-1,3-butadiene and/or 1,3-hexadiene. It is particularly preferable to use 1,3-butadiene and/or isoprene.

Examples of vinylaromatic comonomers that can be used are styrene, o-, m- and/or p-methylstyrene, p-tert-butylstyrene, α-methylstyrene, vinylnaphthalene, divinylbenzene, trivinylbenzene and/or divinylnaphthalene. It is particularly preferable to use styrene.

Particular preference is given to combining 1,3-butadiene, isoprene, 1,3-pentadiene, 2,3-dimethylbutadiene, 1-phenyl-1,3-butadiene and/or 1,3-hexadiene as dienes and styrene, o-, m- and/or p-methylstyrene, p-tert-butylstyrene, α-methylstyrene, vinylnaphthalene, divinylbenzene, trivinylbenzene and/or divinylnaphthalene as vinylaromatic comonomers.

The process of the invention for the production of diene homopolymers and diene copolymers preferably takes place in a solvent. Preferred solvents used for the anionic polymerization process are inert aprotic solvents, e.g. paraffinic hydrocarbons, for example isomeric pentanes, hexanes, heptanes, octanes, decanes, cyclopentane, cyclohexane, methylcyclohexane, ethylcyclohexane or 1,4-dimethylcyclohexane or aromatic hydrocarbons, such as benzene, toluene, ethylbenzene, xylene, diethylbenzene or propylbenzene. The said solvents can be used individually or in combination. Preference is given to cyclohexane and n-hexane. Blending with polar solvents is likewise possible.

The amount of solvent in the process of the invention is usually from 1000 to 100 g, preferably from 700 to 200 g, based on 100 g of the entire amount of monomer used. However, it is also possible to polymerize the monomers used in the absence of solvents.

The polymerization time can vary widely from a number of minutes to a number of hours. The polymerization process is usually carried out within a period of from about 10 minutes up to 8 hours, preferably from 30 minutes up to 3 hours. It can be carried out either at atmospheric pressure or else at an elevated pressure (from 1 to 10 bar).

Once the polymerization process is complete, coupling reactions and/or functionalization reactions can be carried out at the anionic chain end, these being typical of the anionic diene polymerization process. Examples of coupling reagents and/or functionalization reagents are silicon tetrachloride, tin tetrachloride, glycidyl ether, alkoxysilanes, cyclosiloxanes, aminobenzophenones.

The diene homopolymers and diene copolymers produced with the initiator system of the invention usually have average (number-average) molar masses of from 10 000 to 2 000 000 g/mol.

The present invention also provides the use of the initiator system of the invention for the production of diene homopolymers and/or diene copolymers having vinyl content of >60%, based on the diene component.

The examples below serve to illustrate the invention, but with no limiting effect.

### EXAMPLES

### Example 1A

### Synthesis of polybutadiene

The following are used as initial charge, with stirring, in a 2 L steel reactor which has been dried and blanketed with nitrogen: 850 g of hexane, 1.74 mmol of bis[2-(N,N-dimethylamino)ethyl] ether (BDMAEE) (B), 0.29 mmol of sodium 3,7-dimethyl-3-octanolate (Na-DMO) (C) (in the form of 50% strength solution in hexane), 150 g of 1,3-butadiene, 0.58 mmol of n-butyllithium (BuLi) (A) (in the form of 23% strength solution in hexane). The mixture was heated to 80° C. for 60 minutes, with stirring. The rubber solution was then precipitated in ethanol and stabilized with 2,6-di-tert-butyl-4-cresol (BHT). The precipitated rubber was isolated from ethanol and dried at 60° C. in vacuo for 16 h.

Analysis results:
Vinyl content (IR spectroscopy): 94% by weight
Glass transition temperature Tg (DSC): −5° C.
Mooney viscosity (ML1+4 at 100° C.): 95 Mooney units

Examples 1B to 1W were carried out correspondingly with the initiator systems, polymerization temperatures and quantitative proportions stated in Table 1.

Examples 1A to 1I of the invention demonstrate that it is possible to produce polybutadienes having very high vinyl content and very high glass transition temperature at high polymerization temperatures using the initiator system of the invention. This cannot be achieved using the comparative systems of Examples 1J to 1W.

### Example 2A

### Synthesis of a Styrene-butadiene Copolymer

The following are used as initial charge, with stirring, in a 2 L steel reactor which has been dried and blanketed with nitrogen: 850 g of hexane, 4.13 mmol of bis[2-(N,N-dimethylamino)ethyl] ether (BDMAEE) (B), 0.69 mmol of sodium 3,7-dimethyl-3-octanolate (Na-DMO) (C) (in the form of 50% strength solution in hexane), 112 g of 1,3-butadiene, 38 g of styrene, 1.38 mmol of n-butyllithium (BuLi) (A) (in the form of 23% strength solution in hexane). The mixture was heated to 80° C. for 60 minutes, with stirring. The rubber solution was then precipitated in ethanol and stabilized with 2,6-di-tert-butyl-4-cresol (BHT). The precipitated rubber was isolated from ethanol and dried at 60° C. in vacuo for 16 h.

Analysis results:
Vinyl content (¹H NMR; based on the butadiene fraction in the polymer): 87% by weight
Styrene content (¹H NMR): 26% by weight
Glass transition temperature Tg (DSC): 9° C.
Mooney viscosity (ML1+4 at 100° C.): 72 Mooney units

Examples 2B to 2J were carried out correspondingly with the initiator systems, polymerization temperatures and quantitative proportions stated in Table 2.

Examples 2A to 2E of the invention demonstrate that it is possible to produce styrene-butadiene copolymers having very high vinyl content and very high glass transition temperature at high polymerization temperatures using the initiator system of the invention. This cannot be achieved using the comparative systems of Examples 2F to 2J.

TABLE 1
Initiator system, polymerization conditions and product properties of the polybutadienes:

| | | | | | | | Polymer- | Vinyl | | | |
|---|---|---|---|---|---|---|---|---|---|---|---|
| | | | Sodium | | Ratio | Ratio | ization | content | Tg | ML1 + 4 | |
| | | Microstructure | alkoxide | BuLi (A) | (B):(A) | (C):(A) | temperature | [% by | (DSC) | (100° C.) | Conversion |
| Example | Type | regulator (B) | (C) | [mmol] | [mol/mol] | [mol/mol] | [° C.] | wt.] | [° C.] | [MU] | [%] |
| 1A | Inv. | BDMAEE | Na-DMO | 0.58 | 3:1 | 1:2 | 80 | 94 | −5 | 95 | 97 |
| 1B | Inv. | BDMAEE | Na-DMO | 0.58 | 1:1 | 1:2 | 80 | 92 | −6 | 83 | >98 |
| 1C | Inv. | BDMAEE | Na-DMO | 0.75 | 1:1 | 1:2 | 80 | 93 | −6 | 64 | >98 |
| 1D | Inv. | BDMAEE | Na-DMO | 0.58 | 1:2 | 1:2 | 80 | 91 | −11 | 67 | >98 |
| 1E | Inv. | BDMAEE | Na-DMO | 0.58 | 1:1 | 1:1 | 80 | 93 | −6 | 98 | >98 |
| 1F | Inv. | BDMAEE | Na-DMO | 0.58 | 1:1 | 1:4 | 80 | 93 | −9 | 60 | 97 |
| 1G | Inv. | BDMAEE | Na-DMO | 0.58 | 1:1 | 1:2 | 90 | 93 | −7 | 97 | >98 |
| 1H | Inv. | BDMAEE | Na-DMO | 0.58 | 1:1 | 1:2 | 100 | 93 | −6 | 94 | >98 |
| 1I | Inv. | BDMAEE | Na-Menth. | 0.58 | 3:1 | 1:2 | 80 | 93 | −6 | 92 | >98 |
| 1J | Com | BDMAEE | — | 0.75 | 6:1 | — | 80 | 86 | −20 | 46 | 92 |
| 1K | Com | BDMAEE | — | 0.58 | 3:1 | — | 80 | 84 | −23 | 56 | 95 |
| 1L | Com | BDMAEE | — | 0.58 | 1:1 | — | 80 | 81 | −28 | 39 | 94 |
| 1M | Com | BDMAEE | — | 0.58 | 1:1 | — | 100 | 68 | −45 | 31 | 93 |
| 1N | Com | — | Na-DMO | 0.58 | — | 1:2 | 80 | 47 | −64 | 73 | >98 |
| 1O | Com | BEE | Na-DMO | 0.58 | 1:1 | 1:2 | 80 | 74 | −36 | 68 | >98 |
| 1P | Com | BEE | Na-DMO | 0.58 | 3:1 | 1:2 | 80 | 78 | −31 | 62 | >98 |
| 1Q | Com | BEE | Na-DMO | 0.58 | 3:1 | 1:2 | 100 | 74 | −36 | 63 | >98 |
| 1R | Com | DTHFP | Na-DMO | 0.58 | 1:1 | 1:2 | 80 | 69 | −43 | 63 | >98 |
| 1S | Com | DTHFP | Na-DMO | 0.58 | 3:1 | 1:2 | 80 | 71 | −41 | 70 | >98 |
| 1T | Com | TMEDA | Na-DMO | 0.58 | 1:1 | 1:2 | 80 | 76 | −35 | 59 | >98 |
| 1U | Com | TMEDA | Na-DMO | 0.58 | 3:1 | 1:2 | 80 | 82 | −25 | 54 | 98 |
| 1V | Com | TMEDA | Na-DMO | 0.58 | 1:1 | 1:2 | 100 | 71 | −41 | 64 | >98 |
| 1W | Com | TMEDA | Na-DMO | 0.58 | 3:1 | 1:2 | 100 | 80 | −28 | 54 | >98 |

BDMAEE = bis[2-(N,N-dimethylamino)ethyl] ether,
DTHFP = 2,2-di(2-tetrahydrofuryl)propane,
Na-DMO = sodium 3,7-dimethy octanolate,
BEE = 2-(2-ethoxyethoxy)-2-methylpropane,
TMEDA = N,N,N′,N′-tetramethylethylenediamine,
Na-Menth. = sodium menthol
Inv. = of the invention and
Comp. = comparison

TABLE 2
Polymerization conditions and product properties of the styrene-butadiene copolymers

| | | | | | | Polymer- | Vinyl | Styrene | | | |
|---|---|---|---|---|---|---|---|---|---|---|---|
| | | Microstructure | Sodium | Ratio | Ratio | ization | content | content | Tg | ML1 + 4 | |
| | | regulator | alkoxide | (B):(A) | (C):(A) | temperature | [% by | [% by | (DSC) | (100° C.) | Conversion |
| Example | Type | (B) | (C) | [mol/mol] | [mol/mol] | [° C.] | wt.] | wt.] | [° C.] | [MU] | [%] |
| 2A | Inv. | BDMAEE | Na-DMO | 3:1 | 1:2 | 80 | 87 | 26 | 9 | 72 | >98 |
| 2B | Inv. | BDMAEE | Na-DMO | 1:1 | 1:2 | 80 | 88 | 26 | 8 | 42 | >98 |
| 2C | Inv. | BDMAEE | Na-Menth. | 1:1 | 1:2 | 80 | 87 | 26 | 8 | 66 | >98 |
| 2D | Inv. | BDMAEE | Na-DMO | 1:4 | 1:2 | 80 | 83 | 26 | 1 | 17 | >98 |
| 2E | Inv. | BDMAEE | Na-DMO | 1:1 | 1:2 | 100 | 87 | 26 | 6 | 58 | >98 |
| 2F | Comp. | BDMAEE | — | 3:1 | — | 80 | 72 | 27 | −9 | 37 | 96 |
| 2G | Comp. | BEE | Na-DMO | 3:1 | 1:2 | 80 | 73 | 26 | −10 | 21 | >98 |
| 2H | Comp. | DTHFP | Na-DMO | 3:1 | 1:2 | 80 | 65 | 26 | −18 | 37 | >98 |
| 2I | Comp. | TMEDA | Na-DMO | 1:1 | 1:2 | 80 | 74 | 26 | −7 | 19 | >98 |
| 2J | Comp. | TMEDA | Na-DMO | 3:1 | 1:2 | 80 | 76 | 26 | −5 | 33 | >98 |

What we claim is:

1. Initiator system for anionic polymerization comprising
(A) at least one organolithium compound,
(B) at least one di(aminoalkyl) ether and
(C) at least one sodium alkoxide and/or sodium phenoxide.

2. Initiator system according to claim 1, characterized in that the organolithium compound
(A) is a compound of the formula (I)
R-Li (I),
where R is an optionally substituted alkyl moiety having from 1 to 32 carbon atoms, an optionally substituted cycloalkyl moiety having from 3 to 32 carbon atoms or an optionally substituted aryl moiety having from 5 to 36 carbon atoms, which optionally can contain one or more heteroatoms, or R is a secondary aliphatic, cycloaliphatic or aromatic amine moiety.

3. Initiator system according to claim 2, characterized in that the organolithium compound is n-butyllithium and/or sec-butyllithium.

4. Initiator system according to claim 2, characterized in that the di(aminoalkyl) ethers (B) are compounds of the formula (II) 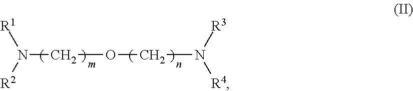
where
R¹, R², R³ and R⁴ are identical or different and are alkyl moieties having from 1 to 12 carbon atoms, cycloalkyl moieties having from 3 to 8 carbon atoms, aryl moieties having from 6 to 10 carbon atoms, or aralkyl moieties having from 7 to 15 carbon atoms,
m and n are identical or different and are whole numbers from 1 to 8.

5. Initiator system according to one or more of claims 1 to 4, characterized in that the sodium alkoxide and/or sodium phenoxide (C) is a compound of the formula (III)
Na—OR′ (III),
where R′ is a linear, branched, saturated or unsaturated optionally substituted C₁-C₃₀-alkyl, C₃-C₁₈-cycloalkyl or C₆-C₁₈-aryl moiety which optionally contains one or more heteroatoms.

6. Initiator system according to claim 5, characterized in that the compounds of the formula (III) are sodium methanoate, sodium ethanolate, sodium n-propanolate, sodium isopropanolate, sodium n-butanolate, sodium sec-butanolate, sodium tert-butanolate, sodium n-pentanolate, sodium iso-pentanolate, sodium hexanolate, sodium cyclohexanolate, sodium 2,4-dimethyl-3-pentanolate, sodium octanolate, sodium 2-ethylhexanolate, sodium decanolate, sodium 3,7-dimethyl-3-octanolate, sodium mentholate, sodium tetrahydrofurfuranolate, sodium phenolate, sodium p-nonylphenolate and/or sodium p-decylphenolate.

7. Initiator system according to one or more of claims 1 to 6, characterized in that the molar ratio of the compound (B) to compound (A) is from 0.01:1 to 100:1.

8. Initiator system according to one or more of claims 1 to 7, characterized in that the molar ratio of compound (C) to compound (B) is from 0.005:1 to 100:1.

9. Initiator system according to one or more of claims 1 to 8, characterized in that the molar ratio of compound (C) to compound (A) is from 0.02:1 to 50:1.

10. Process for the production of the initiator system according to one or more of claims 9, characterized in that components (A) to (C) are mixed.

11. Process for the production of diene homopolymers and/or diene copolymers having vinyl content of >60%, based on the diene component, characterized in that the dienes and/or vinylaromatic comonomers are reacted with the initiator system according to one or more of claims 1 to 9.

12. Process according to claim 11, characterized in that the reaction takes place at polymerization temperatures of >60° C.

13. Process according to claim 11 or 12, characterized in that either the monomers and/or vinylaromatic comonomers are first used as initial charge and then the initiator system or the individual components of the initiator system are added in any desired sequence or components (A) to (C), the monomers and/or vinylaromatic comonomers, and also the solvent, are metered continuously into the reactor.

14. Process according to one or more of claims 11 to 13, characterized in that the dienes used comprise 1,3-butadiene, isoprene, 1,3-pentadiene, 2,3-dimethylbutadiene, 1-phenyl-1,3-butadiene and/or 1,3-hexadiene, and the vinylaromatic comonomers used comprise styrene, o-, m- and/or p-methylstyrene, p-tert-butylstyrene, α-methylstyrene, vinylnaphthalene, divinylbenzene, trivinylbenzene and/or divinylnaphthalene.

15. Use of the initiator system according to one or more of claims 1 to 9 for the production of diene homopolymers and/or diene copolymers having vinyl content of >60%, based on the diene component.
